(19) United States
(12) Patent Application Publication
(10) Pub. No.: US 2010/0040325 A1
(43) Pub. Date: Feb. 18, 2010

(54) Low-cost multimode optical fiber switch

(75) Inventors: Hus Tigli, La Jolla, CA (US); Matthew Last, San Diego, CA (US); David Sandler, San Diego, CA (US)

Correspondence Address: TREX ENTERPRISES CORP., 10455 PACIFIC COURT, SAN DIEGO, CA, 92121, US

(73) Assignee: TREX ENTERPRISES CORP.

(21) Appl. No.: 12/462,641

(22) Filed: Aug. 5, 2009

Related U.S. Application Data
(63) Continuation-in-part of application No. 11/728,435, filed on Mar. 26, 2007.
(60) Provisional application No. 61/188,111, filed on Aug. 5, 2008.

(51) Int. Cl. G02B 6/42; G02B 6/26

(52) U.S. Cl. 385/18; 385/28

(57) ABSTRACT

A low cost, multimode optical fiber switch in which a MEMS mirror is used to serially reflect input light from a plurality of input optical fibers into a single output fiber or from a single optical fiber into a plurality of output fibers. In a planned demonstration prototype the output fiber is located in the center of four input fibers. In other preferred embodiments of the present invention an array of MEMS mirrors are utilized with a large bundle of fibers containing both input and output fibers. Each MEMS mirror is adapted to reflect light from a number of input fibers one-at-a-time into a single output fiber or to reflect light from a single input fiber into a number of output fibers one-at-a-time.

### CROSS REFERENCE TO RELATED APPLICATIONS

The present application is a continuation in part of U.S. patent application Ser. No. 11/728,435, Optical Switch Module, filed Mar. 26, 2007 which is incorporated herein by reference. This application also claims the benefit of Provisional Patent Application Ser. No. 61/188,111 filed Mar. 5, 2008.

### FIELD OF THE INVENTION

The present invention is related to optical switches and in particular to MEMS based optical switches.

### BACKGROUND OF THE INVENTION

Multi-mode optical fiber is a type of optical fiber mostly used for communication over shorter distances, such as within a building or on a campus. Typical multimode links have data rates of 10 Mbit/s to 10 Gbit/s over link lengths of up to 600 meters—more than sufficient for the majority of premises applications. The equipment used for communications over multi-mode optical fiber is much less expensive than that for single-mode optical fiber. Typical transmission speed/distance limits are 100 Mbit/s for distances up to 2 km, 1 Gbit/s to 500-600 m, and 10 Gbit/s to 300 m.

Multimode fiber has higher “light-gathering” capacity than single-mode optical fiber. In practical terms, the larger core size simplifies connections and also allows the use of lower-cost electronics such as light-emitting diodes and vertical-cavity surface-emitting lasers which operate at the 850 nm wavelength (single-mode fibers used in telecommunications operate at 1310 or 1550 nm and require more expensive laser sources. Multimode fibers exist for nearly all visible wavelengths of light). However, compared to single-mode fibers, the limit on speed times distance is lower. Because multimode fiber has a larger core-size than single mode fiber, it supports more than one propagation mode; hence it is limited by modal dispersion, while single mode is not.

### MEMS Mirrors

MEMS mirrors are lithographically produced mirrors that are operated with voltage signals applied through integrated circuits produced with similar lithographic techniques. These mirrors typically are very tiny having dimensions measured in millimeters or fractions of millimeters. They are designed with extremely tight tolerances necessary for proper angular alignment of the various reflective elements, and usually require very sophisticated feedback control systems.

### Automatic All Optical Cross Connect Switches

Recently, a number of optical cross connect switches have become available for switching optical signals directly from one fiber to another, thereby eliminating the need to convert the optical signal to an interim electrical signal. These optical switches incorporate various optical switch elements, such as mirrors, prisms, fiber collimators, and complicated drive mechanisms, to route optical signals through the switch. For some optical switches, MEMS mirrors have been utilized. All optical switches are described in the following patents recently issued which contain features similar to some of the features of the present invention: U.S. Pat. No. 7,190,509, Optically Addressed MEMS and U.S. Pat. No. 7,177,497, Porous Silicon Filter for Wavelength Multiplexing and De-Multiplexing, both of which are incorporated herein by reference.

### Applications of All Optical Automatic Cross Connect Switches

Known uses of all optical cross connect switches include (1) use as the principal component in a automated fiber patch panel, (2) use a component of a reconfigurable optical add drop multiplexer system and (3) use for automatic testing and measurement of optical components and systems.

### Test and Measurement

Automated all optical cross connect switches can greatly simplify testing of optical components especially components of typical communication networks simultaneously carrying millions of messages.

### The Need

Optical fiber switches tend to be very expensive. In many applications the advantages that an optical fiber switch would bring are far outweighed by the cost. What is needed is a low-cost multimode optical fiber switch.

### SUMMARY OF THE INVENTION

The present invention provides a low cost, multimode optical fiber switch with at least one multimode optical fiber bundle comprising a single first directional multimode fiber and a plurality of second directional multimode fibers. At least one MEMS mirror adapted to reflect light to or from the single first directional multimode fiber from or to any one of the plurality of said second directional multimode fibers. Preferably a lens is positioned between each of the first and second directional multimode fibers and the at least one MEMS mirror. In preferred embodiments each MEMS mirror is adapted to reflect light from a number of input fibers one-at-a-time into a single output fiber or to reflect light from a single input fiber into a number of output fibers one-at-a-time. In a preferred embodiment, ten large bundles are combined with each bundle having 90 input fibers and one output fiber and one MEMS mirror assigned to each bundle and programmed to reflect light, one beam at a time, from each of 90 input fibers into the bundle's output fiber. In the preferred embodiment the number of input fibers is 900 and the number of output fibers is 10. Only ten spectrometers are required.

Preferred embodiments use the comb-drive MEMS technology described in the parent patent application. Incoming light is reflected off the tilted mirror and coupled into the desired output fiber through a figured lens system.

### BRIEF DESCRIPTION OF THE DRAWINGS

FIGS. 1 and 2 show a five fiber prototype.

FIG. 3 shows a fiber array.

FIG. 4 shows a 3×3 switch.

FIG. 5 shows a N2×N down-select switch.

### DETAILED DESCRIPTION OF PREFERRED EMBODIMENTS

The details of constructing and controlling the MEMS mirror arrays are described in parent patent application Ser. No. 11/728,436 which is incorporated herein by reference. See especially the sections entitled, “Fabrication for Comb Drives”, “Control of MEMS Mirrors” and “Other Control Techniques”. The attached patent application should also be referred to as to techniques for positioning fibers of fiber bundles.

### Five-Fiber Prototype

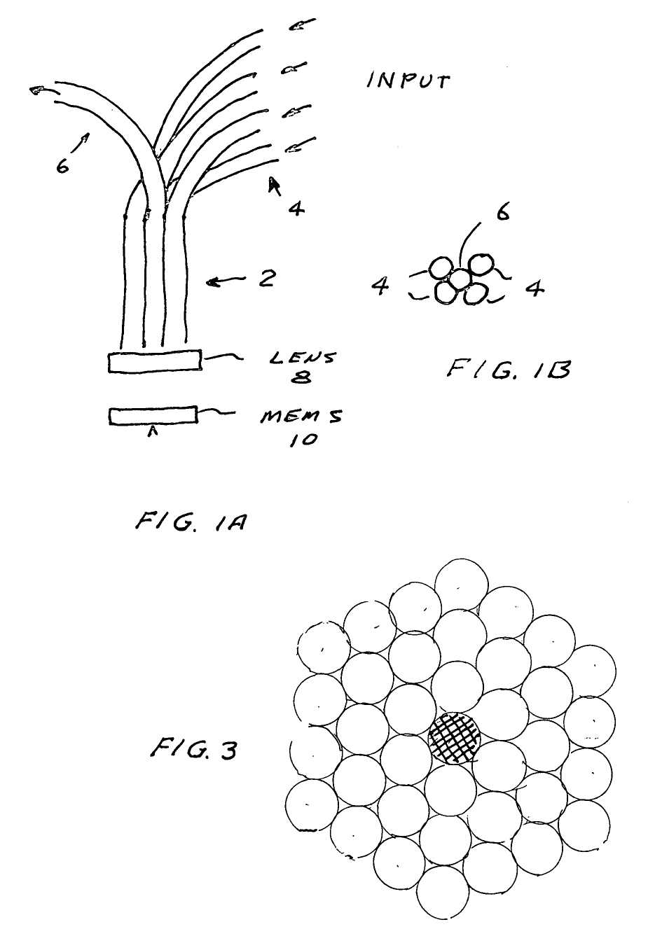

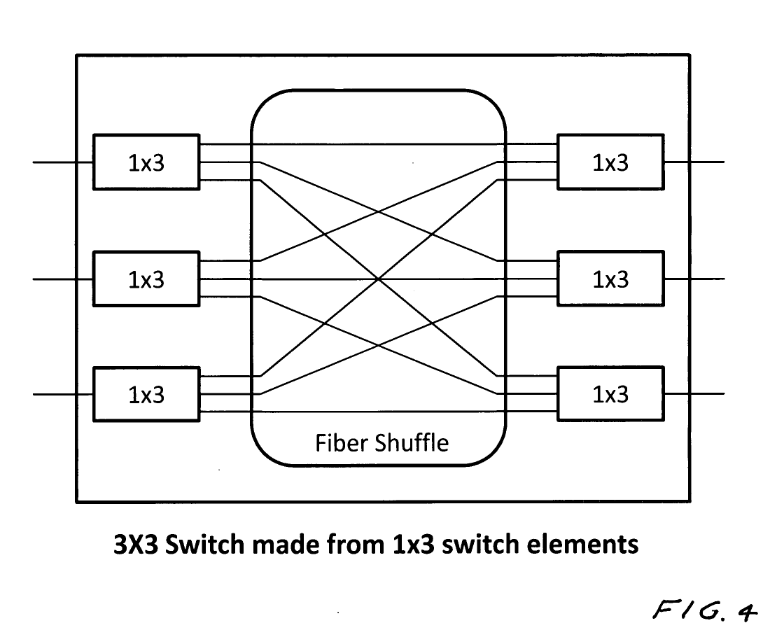

A five-fiber prototype is shown in FIGS. 1 and 2. FIG. 1 shows a cross section of the fiber bundle 2 with the input fibers 4 surrounding the output fiber 6. FIG. 2 is a side view of the prototype with a micro-lens array 8 positioned immediately below the tips of the five fibers and the MEMS mirror 10 positioned just far enough below the microlens array to provide room enough for the maximum required tilt. In a preferred embodiment the output fiber is directed to a spectrometer so that the spectrum of the light in each of the four fibers can be measured with a single spectrometer as often as desired.

### Other Fiber Bundles

In other embodiments the output fiber is in the center of six input fibers surrounding the output fiber. The number of input fibers can be expanded by adding six additional fibers in rings around the circumference of the bundle in each succeeding ring. So this technique would produce bundles of 6, 18, 36, 60, 90 and so forth. Only one MEMS mirror per bundle would be required. These arrangements of cylindrical fibers provide very good fill factors. FIG. 3, for example shows a bundle with one output fiber (shown cross hatched) and 36 input fibers.

### Large Array Embodiments with Combined Fiber Bundles

The present invention is very useful for analysis of astronomy data. In one preferred application, a very large number of multimode fibers are tightly packed with one end positioned in the focal plane of a astronomical telescope. The other ends of the fibers are each arranged in an array similar to the one shown in FIG. 3 so that light from the input fibers can be directed by a MEMS mirror into an output fiber in the middle of the bundle which output fiber takes the light directed to it to a spectrometer where a grating separates the light into spectral ranges which are detected and recorded by a optical detector array. In preferred embodiments each bundle includes 90 input fibers. The whole system is computer controlled to automatically detect and record the spectral data from selected stars in the telescope field of view.

In preferred embodiments 10 fiber bundles, each bundle having one output fiber and 90 input fibers, are combined with one MEMS mirror assigned to 90 input fibers and one output fiber. This produces a switch system that can handle 900 input fibers. Ten MEMS arrays would be needed but only 10 spectrometers would be needed to collect spectral data from the 900 input fibers.

### N×N and N²×N Switches

Embodiments of the present invention can be utilized to create more elaborate fiber optical switches such as an N×N switch and a N2×N switch. Examples are described below:

### N×N Switch

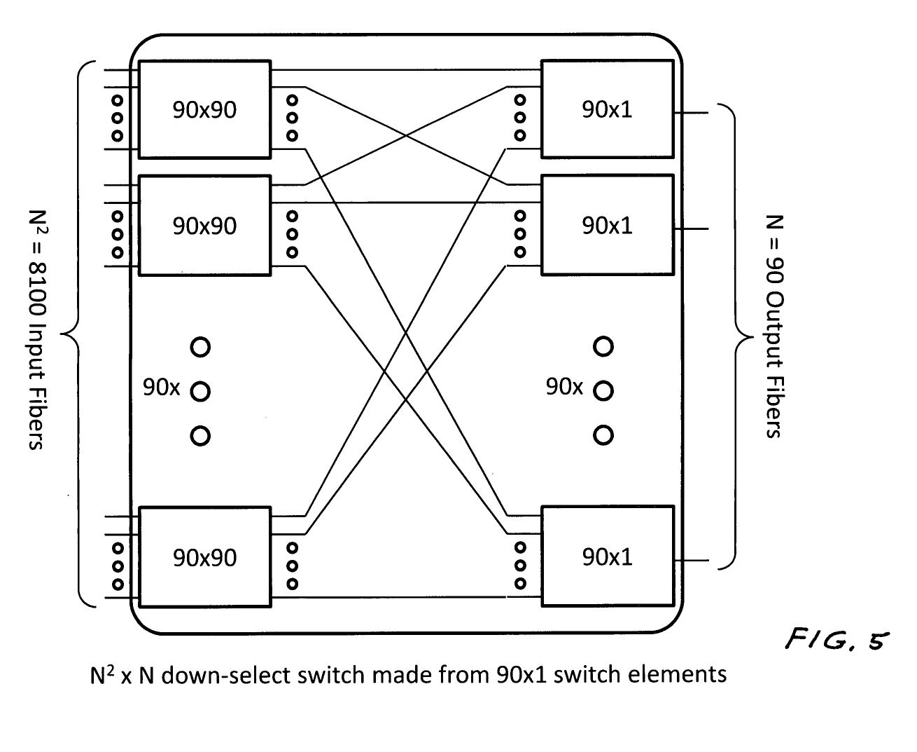

A N×N switch can be made from 1×N switch elements. These 1×N switches are arranged in two banks of N switch elements, for a total of 2N of these 1×N elements for each N×N switch (see FIG. 4 where N is 3). These two banks of switch elements are connected using a “Perfect Fiber Shuffle”, which connects each 1×N switch element in the first bank to every 1×N switch element in the second bank. By symmetry, the converse is also true: each 1×N switch element in the second bank is connected to every 1×N switch element in the first bank. This allows any of the N input fibers to be connected to any of the N output fibers.

### N²×N Switch

An N²×N switch can be made from 1×N switch elements. These 1×N switches are arranged in three banks of N switch elements, for a total of 3N of these 1×N elements for each N²×N switch (see FIG. 5). These three banks of switch elements are connected using “Perfect Fiber Shuffles”, which connects each 1×N switch element in the first bank to every 1×N switch element in the second bank, and each 1×N switch element in the third bank to every 1×N switch element in the second bank. By symmetry, the converse is also true: each 1×N switch element in the second bank is connected to every 1×N switch element in the first bank, and each 1×N switch element in the second bank is connected to every 1×N switch element in the third bank. This allows any of the N input fibers to be connected to any of the N output fibers. In this topology, not all input fibers can be connected to an output fiber at the same time.

### Routing

The 1×N switch elements described in this patent are able to route light from the input fiber to any of a plurality of output fibers. In addition, the input fiber can be also used as the output fiber, retro-reflecting light back along the path through which it came. More generally, it is possible to route incoming light from any one input fiber to any one output fiber. Most generally, a plurality of input fibers can be lit at any time, and the respective input signals routed as a group to a plurality of output fibers. In preferred embodiments, Applicants restrict our attention to the case where there is only one input fiber at any given time that is carrying light.

While the above description contains many specifications, the reader should not construe these as limitations on the scope of invention, but merely as exemplifications of preferred embodiments thereof. Those skilled in the art will envision many other possible variations are within its scope. The switch of the present invention has many other applications that will be clear to persons skilled in the art such as a multi-mode switch at a data center and for cross connecting optical equipment at data centers and for multiplexing. Accordingly, the reader is requested to determine the scope of the invention by the appended claims and their legal equivalents, and not by the examples which have been given.

We claim:

1. A low cost, multimode optical fiber switch comprising:
A) at least one multimode optical fiber bundle comprising:
1) a single first directional multimode fiber and
2) a plurality of second directional multimode fibers;
B) at least one MEMS mirror adapted to reflect light to or from said single first directional multimode fiber from or to any one of said plurality of said second directional multimode fibers.

2. The switch as in claim 1 and further comprising a lens positioned between each of the first and second directional multimode fibers and the at least one MEMS mirror.

3. The switch as in claim 1 wherein the single first directional multimode fiber is an output fiber and the plurality of second directional multimode fibers are input fibers.

4. The switch as in claim 1 wherein the single first directional multimode fiber is an input fiber and the plurality of second directional multimode fibers are output fibers.

5. The switch as in claim 1 wherein said switch is adapted to is used to serially reflect input light from a plurality of input optical fibers into a single output fiber or from a single optical fiber into a plurality of output fibers.

6. The switch as in claim 1 wherein the single first directional multimode fiber is located in the center of the plurality of second directional multimode fibers.

7. The switch as in claim 1 wherein the number of second directional multimode fibers is 6 or more.

8. The switch as in claim 1 wherein the number of second directional multimode fibers is 18 or more.

9. The switch as in claim 1 wherein the number of second directional multimode fibers is 36 or more.

10. The switch as in claim 1 wherein said at least one bundle of multimode fibers is a plurality of bundles of multimode fibers and said at least one MEMS mirror a plurality of MEMS mirrors, each MEMS mirror being adapted to control directions of light beams is one bundle of the plurality of bundles.

11. The switch as in claim 10 wherein the switch is adapted to reflect light from a number of second directional fibers one-at-a-time into a first directional fiber or to reflect light from a first directional fiber into a plurality of second directional fibers one-at-a-time.

12. The switch as in claim 11 wherein the plurality of second directional fibers is at least 10,240 and the number of first directional fibers at least 10.

13. The switch as in claim 12 wherein each of the second directional fibers is adapted to supply light beams to a spectrometer.

14. The switch as in claim 13 wherein the switch is adapted to automatically monitor spectra of stars.

15. The switch as in claim 1 wherein a plurality of optical fiber bundles are arranged to provide an N×N optical fiber switch.

16. The switch as in claim 1 wherein a plurality of optical fiber bundles are arranged to provide an N²×N optical fiber switch.
